(19) United States
(12) Patent Application Publication
(10) Pub. No.: US 2015/0063947 A1
(43) Pub. Date: Mar. 5, 2015

(54) SCREW CAPABLE OF EASILY DRILLING HOLES AND DREGS REMOVING

(71) Applicant: SHU-CHIN HUANG, Kaohsiung (TW)

(72) Inventor: SHU-CHIN HUANG, Kaohsiung (TW)

(21) Appl. No.: 14/014,335

(22) Filed: Aug. 29, 2013

(51) Int. Cl. F16B 35/06

(52) U.S. Cl. CPC F16B 35/065
USPC 411/393

(57) ABSTRACT

A screw capable of drilling holes easily and discharging dregs effectively includes a head; and a stem extending from a lower portion of the head. The head is formed by an upper portion and a lower portion. The upper portion is a round disk. The annular ring of the round disk of the head is formed with a plurality of inclined protrusion. The recesses between the protrusions extend from an inner edge of the round ring to an outer edge of the round ring and are arranged along un-radial paths. A periphery of the lower portion of the head is formed with at least one knife sheet which extends from the annular ring of the round disk of the head to the stem; and the direction of the knife sheet is inclined to an axis of the lower portion of the head.

### FIELD OF THE INVENTION

The present invention relates to screws, and in particular to a screw capable of easily drilling of holes and with the function of dregs removing.

### BACKGROUND OF THE INVENTION

Screws have different features based on the objects to be drilled. These features are aimed at to have preferred drilling speed, high dregs removing rate, and easiness in drilling operation. However, the dregs generated in drilling will be left in the drilling hole, but this residue left in the hole is possible to cause that the object to be drilled cracks. The main reason of such a defect is that the dregs left in the hole will further expand the hole to have a larger size, as a result the object to be drilled cracks. A further reason is that the outer diameter of the screw head is larger than an inner diameter of the hole. Then the screw head is embedded into the hole, it is possible that the hole will crack. It is desired to cut, expand and smooth the hole before embedding the screw head so that the larger screw head can be flatly embedded into the hole with an easy and comfortable operation. Furthermore, no cracking forms and the edge of the hole is smooth.

### SUMMARY OF THE INVENTION

The object of the present invention is to provide a screw capable of drilling holes easily and removing dregs effectively, which has the advantages of providing a screw by which the screw head can be easily embedded into the drilling hole with a crack-proof effect; proving a screw by which the drilling hole can be cut and expanded before embedding the screw head for dregs removing so that the screw head can be embedding to the drilling hole smoothly; providing a screw by which the edge of the drilling hole will not expose out.

To achieve above object, the present invention provides a screw capable of easily drilling holes and dregs removing, comprising: a head and a stem extending from a lower portion of the head; the head and the stem being formed integrally; the head being formed by an upper portion and a lower portion; the upper portion being a round disk with flat upper surface; and the lower portion being an expanding from a lower side of the round disk and being connected to the stem; a lower surface of the round disk disconnected to the lower portion is formed as an annular ring; wherein the annular ring of the round disk of the head is formed with a plurality of inclined protrusion; the recesses between the protrusions extend from an inner edge of the round ring to an outer edge of the round ring and are arranged along un-radial paths; and a periphery of the lower portion of the head is formed with at least one knife sheet which extends from the annular ring of the round disk of the head to the stem with a predetermined distance; and the direction of the knife sheet is inclined to an axis of the lower portion of the head.

### BRIEF DESCRIPTION OF DRAWINGS

FIG. 1 shows the embodiment of the present invention.

FIG. 2 shows another embodiment of the present invention.

FIG. 3 shows a further embodiment of the present invention.

FIG. 4 is a cross sectional view along line B-B of FIG. 3.

FIG. 5 shows yet an embodiment of the present invention.

FIG. 6 is a cross sectional view viewed from a line C-C of FIG. 5 of the present invention.

FIG. 7 shows a further embodiment of the present invention.

FIG. 8 is a schematic view viewed from a line D-D of FIG. 7 of the present invention.

FIG. 9 shows an embodiment showing a flat annular ring according to the present invention.

FIG. 10 shows an embodiment showing a teethed annular ring according to the present invention.

FIG. 11 shows another embodiment of the present invention.

FIG. 12 shows another embodiment of the present invention.

FIG. 13 shows another embodiment of the present invention.

FIG. 14 shows another embodiment of the present invention.

FIG. 15 shows another embodiment of the present invention.

FIG. 16 shows another embodiment of the present invention.

FIG. 17 shows another embodiment of the present invention.

FIG. 18 shows another embodiment of the present invention.

FIG. 19 shows another embodiment of the present invention.

FIG. 20 shows another embodiment of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

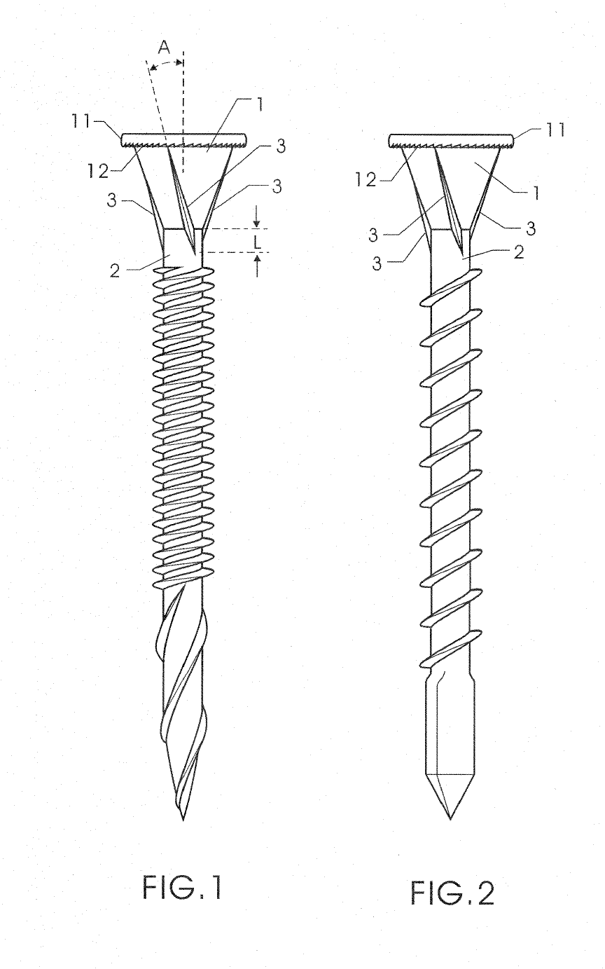

With reference to FIGS. 1 and 2, the structure of the present invention is illustrated.

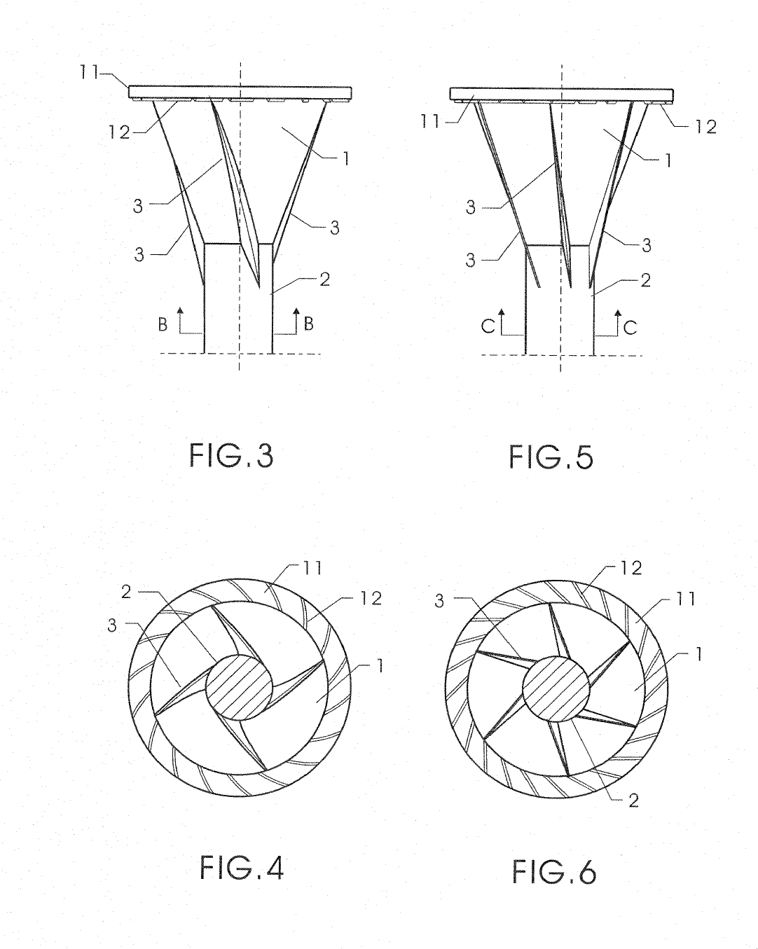

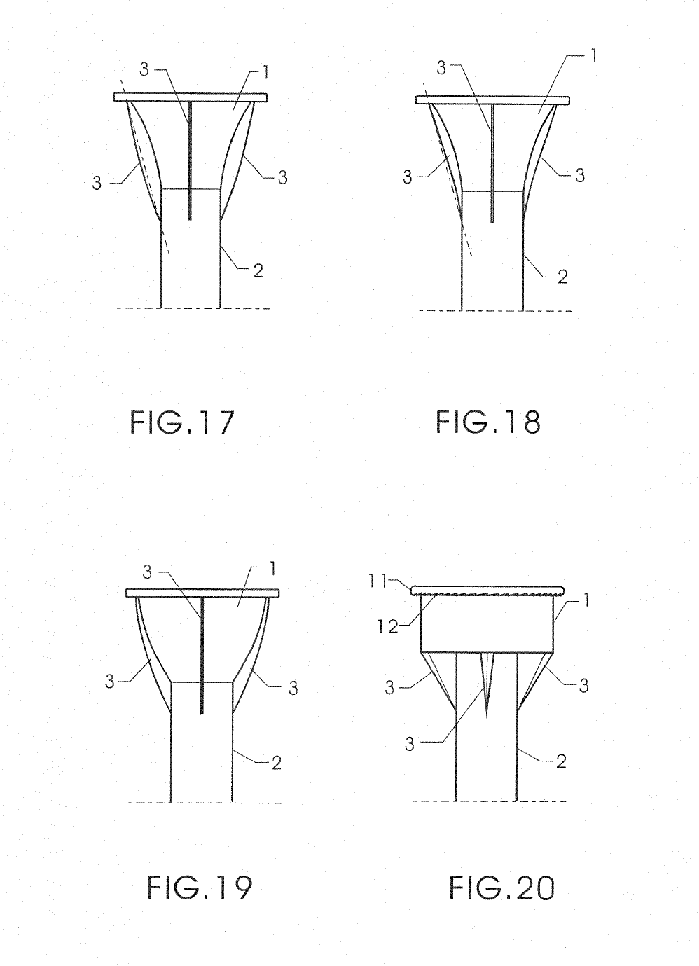

Referring to FIGS. 1 and 2, the embodiment of the present invention is illustrated, wherein the design of the present invention can be widely used for crack-proof screws and wood screws, and others for drilling holes and dregs removing. With reference to FIGS. 3 to 20, it is illustrated that the present invention can be widely used in trumpet form screws, tapered screws or post form screws. The details of these screws will be described screws or post form screws. The details of these screws will be described hereinafter.

With reference to FIGS. 1 and 2, the screw of the present invention includes a head 1 and a stem 2 which is formed integrally.

A lower portion of the head 1 has a round tapered shape and is connected to the stem 2 at the lowermost end thereof. An upper portion of the round tapered head 1 is formed as a flat round disk 11. A lower side of the round disk 11 is connected to an upper end of the lower tapered portion of the head 1. A lower side of the round disk unconnected to the tapered portion is formed as an annular ring as illustrated in FIGS. 4 and 6.

The annular ring of the round disk 11 of the head 1 is formed with a plurality of inclined protrusion 12. The recesses between the protrusions 12 are arranged along un-radial paths. These recesses may be straight lines (referring to FIG. 6) or cambered (referring to FIG. 4).

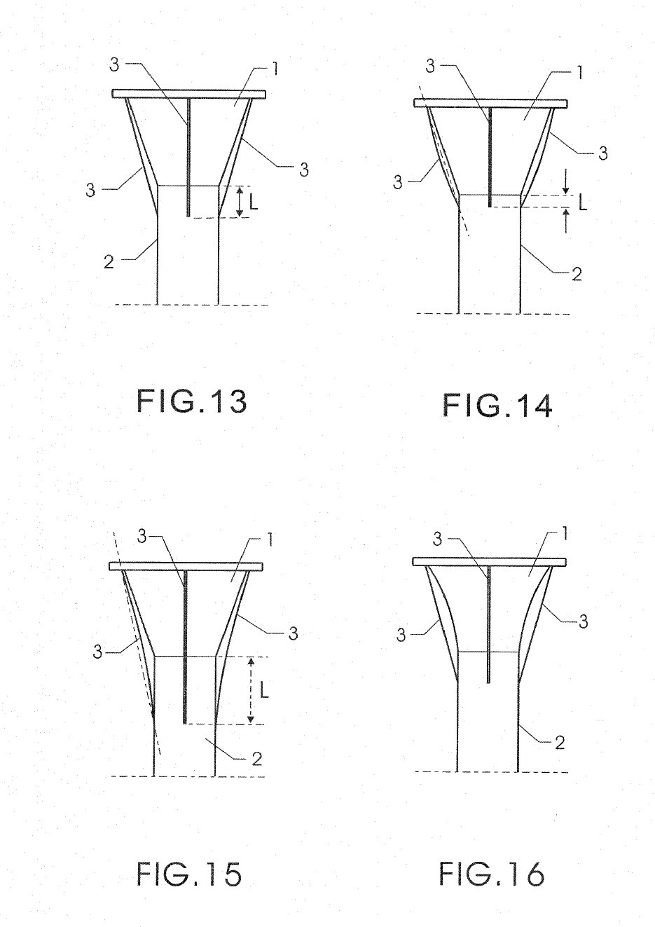

A periphery of the lower tapered portion of the head 1 is formed with at least one knife sheets 3 which extended from the annular ring of the round disk 11 of the head 1 to the stem 2. Furthermore, the knife sheets 3 are extended to a distance L of the stem 2. The direction of the knife sheet 3 is inclined to the axis of the lower tapered portion of the head 1. The knife edge of the knife sheet 3 may be straight (referring to FIGS. 1 to 3, 5, 7, 12 and 16) or inwardly cambered (referring to FIGS. 15 and 18) or outwardly cambered (referring to FIGS. 14, 17 and 19). Two sides of the knife edge of the knife sheet 3 may be formed with cut planes (referring to FIG. 20). The direction of the knife edges of the knife sheet 3 can be non-radial (referring to FIGS. 1 to 12), or radial (referring to FIGS. 13 to 20).

With reference to FIGS. 3 and 4, an lower surface of each protrusion of the annular ring of the head 1 is parallel to the upper surface of the round disk 11. The recesses between the protrusions 12 of the annular ring of the head 1 are not radially arranged and are cambered; and the knife edges of the knife sheets 3 are not radially arranged and are cambered. That is, the knife edge has an inclined angle A with respect to the axis of the lower tapered portion of the head 1. Referring to FIGS. 5 and 6, the protrusions 12 of the annular ring of the head 1 is parallel to the upper surface of the round disk 11. The recesses between the protrusions 12 of the annular ring of the upper portion of the head 1 are not radially arranged and are straight; and the knife edges of the knife sheets 3 are not radially arranged and are straight. That is, the knife edge has an inclined angle A with respect to the axis of the lower tapered portion of the head 1.

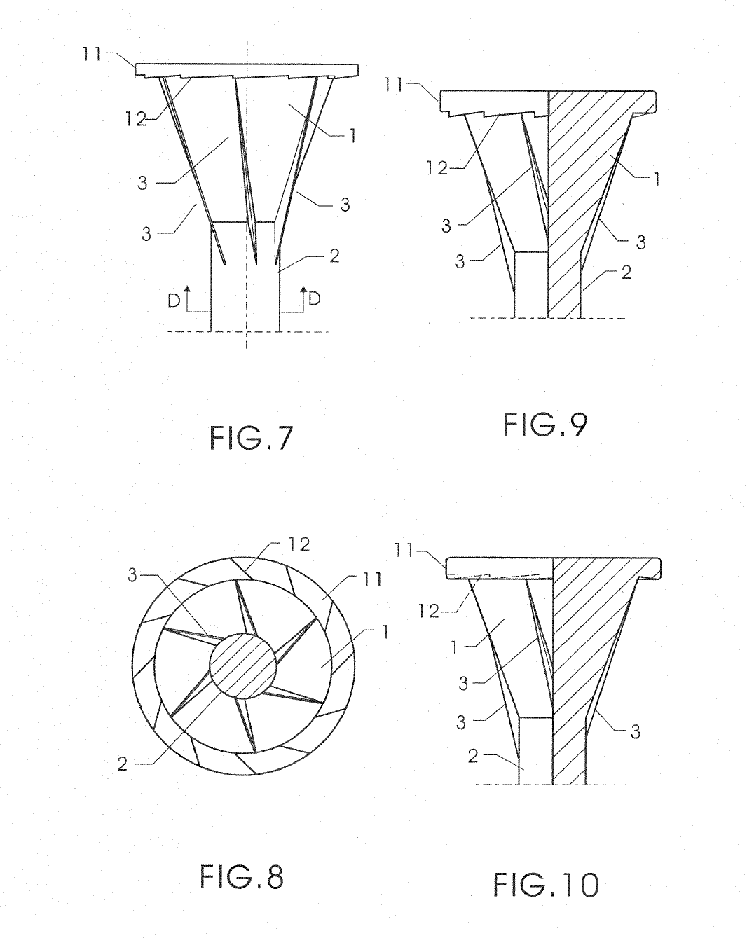

Referring to FIGS. 7 and 8, a lower surface of each protrusions of the annular ring of the head 1 is not parallel to the upper surface of the round disk 11. The recesses between the protrusions 12 of the annular ring of the head 1 are not radially arranged and are straight; and the knife edges of the knife sheets 3 are not radially arranged and are straight. That is, the knife edge has an inclined angle A with respect to the axis of the lower tapered portion of the head 1.

In FIG. 9, the lower annular ring 11 is flat and in FIG. 10, the annular ring has a teethed surface.

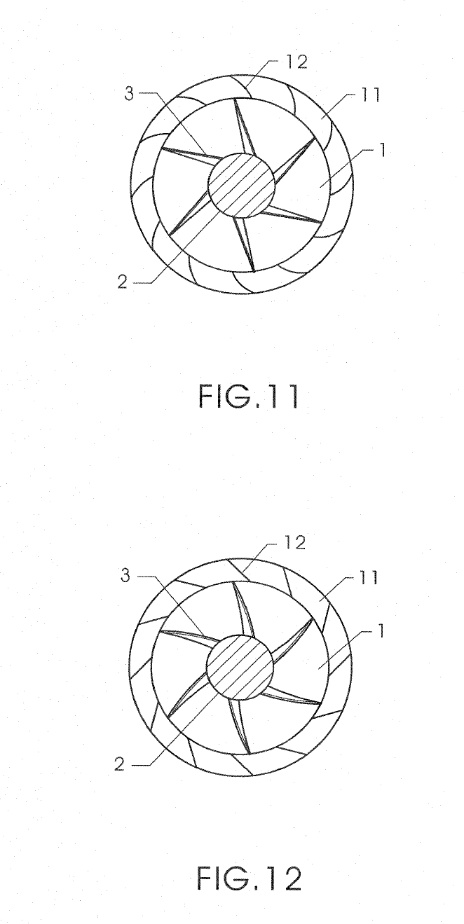

As illustrated in FIG. 11, the recesses between the protrusions 12 of the annular ring of the upper portion of the head 1 are not radially arranged and are cambered; and the knife edges of the knife sheets 3 are not radially arranged and are straight. That is, the knife edge has an inclined angle A with respect to the axis of the lower tapered portion of the head 1.

As illustrated in FIG. 12, the recesses between the protrusions 12 of the annular ring of the upper portion of the head 1 are not radially arranged and are straight; and the knife edges of the knife sheets 3 are not radially arranged and are cambered. That is, the knife edge has an inclined angle A with respect to the axis of the lower tapered portion of the head 1.

Referring to FIGS. 13 and 16, it is illustrated that the knife edge of the knife sheet 3 is straight.

With reference to FIGS. 13, 17 and 19, it is illustrated that the knife edge of the knife sheet 13 is outwardly cambered.

With reference to FIGS. 15 and 18, it is illustrated that the knife edge of the knife sheet 13 is inwardly cambered.

With reference to FIG. 20, it is illustrated that the lower portion of the head 1 is a round cylinder and the knife sheet 3 is only at the stem 2.

By above mentioned structure of the present invention, when the screw drills into an object, the outer diameter of the head 1 is greater than that of the stem 2, and the dregs generated in drilling will hinder the drilling operation of the screw. The knife sheets 3 of the present invention has the effect of cutting and expanding the drilling hole further so that dregs can be discharged effectively and thus the screw can drill into the object easily. The protrusions 12 at the annular ring of the head 1 have the effect of preventing the expose of the dregs and presenting a flat outer look.

The present invention is thus described, However, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw capable of drilling holes easily and discharging dregs effectively, comprising:
a head; and
a stem extending from a lower portion of the head; the head and the stem being formed integrally;.
wherein the head is formed by an upper portion and a lower portion; the upper portion is a round disk; and the lower portion of the head extends from a lower side of the round disk to an uppermost end of the stem; a lower surface of the round disk disconnected to the lower portion is formed as an annular ring;
wherein the annular ring of the round disk of the head is formed with a plurality of inclined protrusion; the recesses between the protrusions extend from an inner edge of the round ring to an outer edge of the round ring and are arranged along un-radial paths; and
wherein a periphery of the lower portion of the head is formed with at least one knife sheet which extends from the annular ring of the round disk of the head to the stem; the knife sheets extends into the stem with a predetermined distance; and the direction of the knife sheet is inclined to an axis of the lower portion of the head.

2. The screw as claimed in claim 1, wherein the at least one knife sheet is cambered and is arranged spirally.

3. The screw as claimed in claim 1, wherein the at least one knife sheet is straight.

4. The screw as claimed in claim 1, wherein the protrusions are cambered.

5. The screw as claimed in claim 1, wherein the protrusions are straight.

6. The screw as claimed in claim 1, wherein a knife edge of the knife sheet is inwardly cambered.

7. The screw as claimed in claim 1, wherein a knife edge of the knife sheet is outwardly cambered.

8. The screw as claimed in claim 1, wherein two lateral sides of a knife edge of the knife sheet is cut with a cut surface.
